(19) United States
(12) Patent Application Publication
(10) Pub. No.: US 2023/0273312 A1
(43) Pub. Date: Aug. 31, 2023

(54) Method and Apparatus for Providing a Classification Result for Object Identification Using Ultrasound-Based Sensor Systems in Mobile Devices

(71) Applicant: Robert Bosch GmbH, Stuttgart (DE)

(72) Inventors: Juergen Schmidt, Sindelfingen (DE); Lena Bendfeld, Stuttgart (DE); Michael Tchorzewski, Boeblingen (DE); Tobias Wingert, Leonberg (DE); Tom Reimann, Bissingen An Der Teck (DE)

(21) Appl. No.: 18/171,010

(22) Filed: Feb. 17, 2023

(30) Foreign Application Priority Data
Feb. 28, 2022 (DE) 10 2022 202 036.7

(51) Int. Cl. G01S 15/89; G06V 10/764; G06V 20/56

(52) U.S. Cl. CPC G01S 15/89; G06V 10/764; G06V 20/56

(57) ABSTRACT

A method for operating an ultrasonic sensor system having an ultrasonic sensor device for determining an object property of an environment object, in which classification models for determining classification results which specify a modeled object property of the environment object are provided for a plurality of detection situations of the environment object, each classification model trained for evaluation with a different subset of signal characteristics extracted from ultrasonic reception signals to provide a classification result of the corresponding classification model and an associated quality specification, includes: detecting the ultrasonic reception signals; determining the quantity of signal characteristics from the ultrasonic reception signals; determining classification results and associated quality specifications by evaluating the classification models with the corresponding subset of the quantity of the signal characteristics on the basis of the detection situation; and determining the object property based on the classification results and associated quality specifications.

This application claims priority under 35 U.S.C. § 119 to application no. DE 10 2022 202 036.7, filed on Feb. 28, 2022 in Germany, the disclosure of which is incorporated herein by reference in its entirety.

The disclosure relates to ultrasonic sensor systems for mobile devices, such as motor vehicles, and in particular to an efficient classification of collision-relevant environment objects.

### BACKGROUND

Vehicles are generally equipped with ultrasonic sensor systems for object detection. These often have a plurality of ultrasonic sensor devices, each having a plurality of ultrasonic transducers for different detection regions in which environment objects are to be detected. The evaluation of the ultrasonic reception signals usually takes place to detect the position of environment objects. Separate classification models are used to distinguish between collision-relevant environment objects and those that can be traveled over. While conventional approaches analyze for example the signal strength of low objects with respect to limit values, more complex approaches provide for developing decision trees or using machine-learning methods for such classification tasks.

The use of data-based classification models for object identification of environment objects requires a large number of characteristics derived from the ultrasonic reception signals. In order to train such a classification model, the ultrasonic reception signals for example scenarios are recorded, the classification features are determined, and a label is assigned to the classification features that indicates whether the environment object is an object that can be traveled over or is collision-relevant. Training data thus determined are then used for training the data-based classification model. Possible classification models can comprise, for example, neural networks or random-forest models.

### SUMMARY

According to the disclosure, a method for object identification of environment objects of an ultrasound-based sensor system in a mobile device, a corresponding apparatus, and an ultrasonic sensor system are provided.

According to a first aspect, a method for operating an ultrasonic sensor system, which has an ultrasonic sensor device, for determining an object property of an environment object is provided, wherein in each case a classification model for determining a classification result which specifies a modeled object property of the environment object is provided for one of a plurality of regions of detection situations of the environment object, wherein each classification model is trained for evaluation with a different subset of a quantity of signal characteristics extracted from ultrasonic reception signals of the ultrasonic sensor device in order to provide a classification result of the corresponding classification model and an associated quality specification in each case, said method having the following steps:
detecting the ultrasonic reception signals of ultrasonic transducers of the ultrasonic sensor device;
determining the quantity of signal characteristics from the ultrasonic reception signals;
determining one or more classification results and associated quality specifications by evaluating one or more of the classification models with the corresponding subset of the quantity of signal characteristics; and
determining the object property on the basis of the one or more classification results and associated quality specifications.

The method can comprise the further steps of:
determining a detection situation of the environment object, in particular by localization with the aid of the ultrasonic sensor device; detection situation;
selecting a current classification model on the basis of the determined determining a classification result using the current classification model;
determining the object property on the basis of the classification results and associated quality specifications.

For the use of a data-based classification method, ultrasound data of relevant environment objects are required for training the classification model. The environment objects are detected by means of the ultrasonic sensor system and the resulting ultrasonic reception signals are evaluated. The ultrasonic reception signals are evaluated by means of a characteristic extraction of signal characteristics from the profiles of the ultrasonic reception signals and assignment of the extracted signal characteristics to a relevant object property of the environment object in question, namely whether the object can be traveled over or is collision-relevant. This classification corresponds to a label of training data which assign the label to a vector of signal characteristics and which are used for training the relevant classification model.

Signal characteristics can be aggregated variables from the ultrasonic reception signals, such as maximum amplitude, time of the maximum amplitude, phase position between two reception signals, as well as further attributes, such as a currently measured amplitude, an extent of the object, a detection rate, a number of average received signal peaks/transmission pulses (multi-reflectivity), a number of ultrasonic transducers that can receive the environment object, a signal stability during the movement of the mobile device, a quotient of the traveled distance and the measured object distance, a number of found intersection points of echo circuits of adjacent ultrasonic transducers, and the like.

The ultrasonic reception signals depend in a considerable manner on a detection situation which is determined by an installation position of the ultrasonic transducers, a geometric position of the environment object, the relative speeds thereof and/or the environmental conditions, such as temperature or subsurface. In order to take these factors into account sufficiently in the classification model, a large number of signal characteristics is necessary, wherein, depending on the detection situation, different subsets of the signal characteristics are particularly relevant for the classification result, while the other signal characteristics have only subordinate importance for the classification result. A classification model that is trained based on all possible signal characteristics would have a high order and thus a high resource consumption during subsequent application. The effort for creating the classification model would also be high, since a database of training data would have to take into account the combination of all influences over as much of the space as possible.

According to the above method, it is now provided to train and apply different classification models on the basis of a detection situation. The detection situation can comprise, for example, the position of the environment object to be detected, the speed of the mobile device (vehicle), and the like. Depending on the detection situation, a different subset of signal characteristics can now be used for training the corresponding classification model. In this way, signal characteristics which are not relevant or are only slightly relevant for the object identification in the relevant detection situation can be masked out in order to provide the classification models to be trained and provided for a significantly reduced dimensionality of signal characteristics. For example, in the case of an ultrasonic sensor system of a vehicle that is provided with 12 ultrasonic transducers, a division of the detection region as part of the detection situation into e.g. four detection situations is expedient. These correspond to a relative movement in the mid and far region in front of the bumper, a movement in the near region in front of the bumper, a standstill, and during a movement in a side region of the vehicle.

For a detection situation of a movement in the mid and far region, the environment object can be detected by all ultrasonic transducers, and ultrasonic reception signals can be collected over different distances. In addition, reflections from the ground proximity, such as the channel between the environment object and the ground, can be detected. In particular, this detection situation can be defined by all regions in which the environment object has a greater distance than a predetermined distance value.

Furthermore, a movement in a near region in front of the bumper of the vehicle (as an example of a mobile device) can be defined as a detection situation. In the near region, ground proximity information is lost, which has a significant influence on the signal characteristics, since there is less multi-reflectivity of the environment object. Therefore, low objects can no longer be detected based on signal characteristics relating to multi-reflectivity. In particular, this detection situation can be defined by all regions in which the environment object has a smaller distance than the predetermined distance value.

A further detection situation involves a standstill of the vehicle, i.e. the relative movement between the environment object and the vehicle. For this detection situation, all signal characteristics which are based on the ultrasonic reception signals changing over several distances or during a movement are unusable.

A further detection situation exists when the environment object is located to the side of the vehicle. Here, the environment objects are only detected by some of the ultrasonic transducers, but from different detection angles. In addition, the detection point at the environment object may change whilst driving past. The distance from the environment object remains either constant or changes only together with the detection angle and cannot be used independently as a signal characteristic. This makes all signal characteristics that have to be evaluated at different distances unusable. The detection situation can be defined, for example, by all regions that lie only in a region of a detection region of an ultrasonic transducer being determined. In the simplest case, the detection situation can be detected for evaluation, in particular based on a location and speed detection, and then the associated classification model can be selected.

In general, quality specifications are determined for the classification models in addition to the classification result. The quality specification results from the level of the element value of the argmax of the classification vector, i.e. the value of the element of the classification vector with the highest value.

It can be provided that each of the classification models with the relevant subset of the quantity of signal characteristics is evaluated in order to obtain the corresponding classification result and the associated quality specification, wherein the object property is determined by the classification result of which the quality specification indicates the highest quality.

If all classification models are used during operation of the ultrasonic sensor system to determine a classification result, the quality specifications of all classification models can thus be used in order to always use the classification result with the highest quality specification, i.e. the quality specification indicating the highest reliability of the classification result.

Upon determining that an environment object leaves a detection situation, the classification result last determined with the classification model assigned to this detection situation and the associated quality specification can be temporarily stored, wherein the determination of the object property is determined on the basis of the classification result obtained with the current classification model and the associated quality specification and on the basis of the temporarily stored classification result and the associated quality specification.

In particular, the object property can be determined by the temporarily stored classification result as long as its associated quality specification indicates a higher quality than the quality specification of the classification result determined with the current classification model.

In an alternative embodiment, only the classification model assigned to the corresponding detection situation can be calculated in a detection situation. The particular classification result is used and stored with the associated quality specification. In the transition to a further detection situation, the classification model assigned to the corresponding detection region can now be used and the classification result and the corresponding quality specification can be determined there. However, the classification result with the corresponding quality specification previously determined with the previous classification model is used as the relevant classification result as long as the quality of the current evaluation of the current classification model indicated by the quality specification does not exceed the quality of the previous evaluation indicated by the quality specification.

Furthermore, when determining that an environment object leaves a detection situation, the signal characteristics which are based on historical profiles of the ultrasonic reception signals can be reset.

In the case of a transition from one detection situation to a further detection situation, the signal characteristics are generally calculated in each case only for the current classification model and are reset to a further classification model during the transition, so that signal characteristics based on historical ultrasonic reception signals are recalculated. Signal characteristics not used in the current classification model are kept to invalid values, which, in classification models, generally effects a deterioration in the quality specification by the classification model.

By using a plurality of classification models, the effort for the creation of training databases can be significantly reduced.

According to a further aspect, an apparatus is provided for carrying out one of the above methods.

### BRIEF DESCRIPTION OF THE DRAWINGS

Embodiments are explained in more detail below with reference to the accompanying drawings. In the drawings:

FIG. 1 shows a schematic representation of a vehicle with an ultrasonic sensor system with an ultrasonic sensor device; and

FIG. 2 shows a flow chart for illustrating a method for operating the ultrasonic sensor system of FIG. 1.

### DETAILED DESCRIPTION

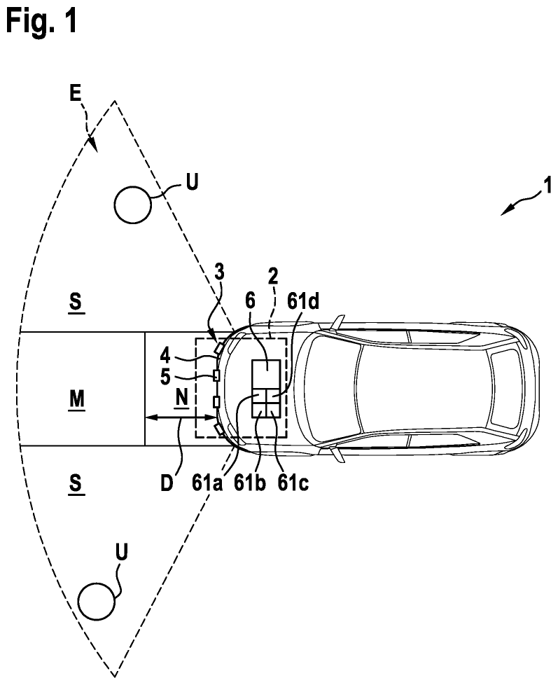

FIG. 1 shows a schematic representation of a vehicle 1 in a vehicle environment in which one or more environment objects U are located. The vehicle 1 as an example of a mobile device comprises an ultrasonic sensor system 2 with an ultrasonic sensor device 3 which is arranged on a front bumper 4.

The ultrasonic sensor device 3 comprises a plurality of ultrasonic transducers 5 for emitting an ultrasonic signal with signal pulses and for receiving ultrasonic signals reflected at the environment objects U in a detection region E.

A control unit 6 is provided which serves to evaluate the ultrasonic reception signals (sensor signals) of the ultrasonic transducers 5 of the ultrasonic sensor device 3. A plurality of classification models 61a, 61b, 61c, 61d are implemented in the control unit 6 and are trained separately on different detection situations with respect to the ultrasonic sensor device 3.

The ultrasonic reception signals are further evaluated in a manner known per se with the aid of ultrasound-based localization methods in order to create a virtual map of the environment in the control unit 6 and to introduce there the positions of detected environment objects U. Classification results are assigned to the detected environment objects U with the aid of the relevant classification model 61a, 61b, 61c, 61d. The classification results classify the environment objects U according to relevant properties for the driving mode of the vehicle. The classification results can indicate, for example, that the relevant environment object U can be traveled over and is collision-relevant. This feature is based on the height of the environment object above the ground.

The data-based classification models 61a, 61b, 61c, 61d assign a classification vector to an input variable vector comprising signal characteristics from the ultrasonic reception signals of the ultrasonic transducers. The classification vector comprises an element of the classification result for each possible class. By means of an argmax function, the specific class can be output as a classification result for the model evaluation. The value of the element determined by argmax corresponds here to the quality specification for the classification result.

In order to classify a detected environment object, a plurality of classification models 61a, 61b, 61c, 61d are used for different detection situations according to this disclosure. For this purpose, a detection situation can be determined for each environment object U and the classification model to be used can be selected accordingly.

The detection situation can comprise the position of the environment object relative to the ultrasonic sensor system 1 and, if applicable, the speed of the environment object U relative to the ultrasonic sensor system. Further factors may indicate surface conditions, wetness, and the like, for example.

In the following, the relative position of the environment object U and its relative speed are assumed as detection situations. In the exemplary embodiment shown, a distinction is made between four detection situations for an environment object U:
the moving environment object U is located in an upcoming mid and far region M, i.e. environment objects with a relative position indicating a distance of greater than D from the ultrasonic sensor system,
the moving environment object U is located in a near region N for a distance of the environment object from the ultrasonic sensor system less than the predetermined distance D,
the moving environment object U is located in one of two side regions S which is arranged to the side of the driving channel in the direction of travel and is defined in that not all ultrasonic transducers are able to receive an ultrasonic reception signal originating from the corresponding environment object U, and
the vehicle is stationary or there is no relative movement between the environment object U and the ultrasonic sensor system 1.

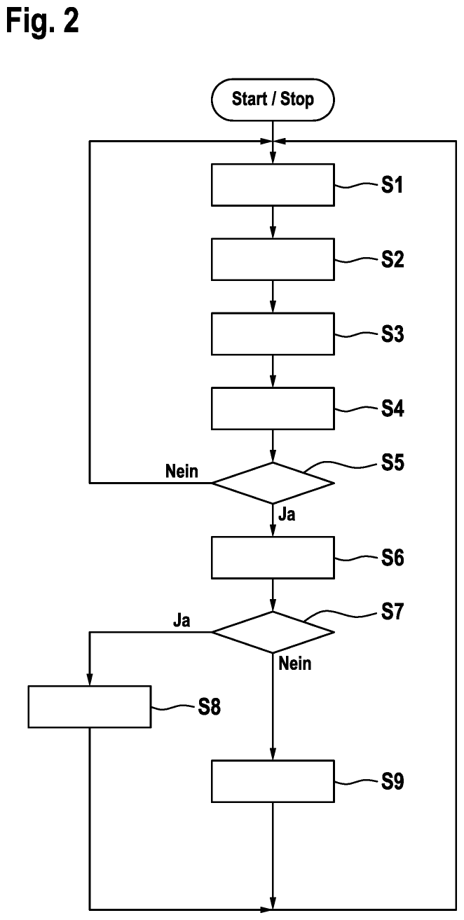

FIG. 2 shows a flow chart for illustrating a method which is carried out in the control unit 6 of the ultrasonic sensor system 1.

In step S1, the relative positions of environment objects U and their relative speeds with respect to the ultrasonic sensor system 1 are first detected with the aid of position determination models.

In step S2, a corresponding one of the classification models 61a, 61b, 61c, 61d is selected for each of the detected environment objects U and is intended to decide whether the corresponding environment object U is collision-relevant or can be traveled over. The associated classification model 61a, 61b, 61c, 61d in which the detection situation of the environment object U in question is assigned to the relevant classification model 61a, 61b, 61c, 61d is selected.

The selected classification model is now used in step S3 to select a corresponding classification result, i.e. a statement as to whether the relevant environment object is collision-relevant or can be traveled over. The classification model for this purpose uses signal characteristics of the ultrasonic reception signals of the ultrasonic transducers and evaluates them. The signal characteristics can be aggregated variables from the ultrasonic reception signals and can characterize e.g. a temporal profile of the ultrasonic reception signals.

In a corresponding manner, the classification models are each trained such that they perform an evaluation of the classification model with a subset of signal characteristics determined from the ultrasonic reception signals in order to obtain a classification result.

Furthermore, in step S4, in addition to the classification result, a quality specification is also determined, which can be read, for example, from the degree of an assignment to a specific class in the classification result. Thus, in various exemplary embodiments, the environment objects U can be characterized as collision-relevant or capable of being traveled over, which can correspond to two different classes. The corresponding classification vector now specifies an output value between 0 and 1 for each of the classes, wherein 1 corresponds to a reliable estimation of the association with a class. 0 corresponds to the greatest possible uncertainty of the association with this class.

Now, in step S5, it is checked whether the detection situation has changed and whether a detection situation is present which is assigned a different classification model. If this is the case (alternative: yes), the method is continued with step S6; otherwise it is returned to step S1.

In step S6, an evaluation is performed according to the classification model newly assigned to the changed detection region. Before this, the classification result last made with the previous classification model is temporarily stored and the associated quality specification of the classification result is also temporarily stored.

In step S7, the quality specification of the new classification result is compared with the temporarily stored quality specification. If the current evaluation with the new classification model yields a classification result with a lower quality specification (alternative: yes), in step S8 the temporarily stored classification result is used as the classification result to be determined, otherwise (alternative: no), i.e. the quality specification of the evaluation in the new classification model is higher than the temporarily stored quality specification, the newly determined classification result is used in step S9 as the classification result to be determined.

In the case of a transition of the detection situation to a detection situation assigned to another classification model, the signal characteristics are generally calculated in each case only for the current classification model and the underlying historical profiles of the ultrasonic reception signals are reset to a further classification model during the transition, so that signal characteristics based on historical ultrasonic reception signals are recalculated. Signal characteristics not used in the current classification model are kept to invalid values, which, in classification models, generally effects a deterioration in the quality specification by the classification model.

In an alternative embodiment, the classification models of all detection situations can be evaluated in parallel during operation. The classification result for which the highest quality specification results is then used. Thus, in particular in boundary regions between two detection situations, the classification model that indicates the greater reliability (quality specification) in the evaluation can thus be trusted to a greater extent.

1. A method for operating an ultrasonic sensor system, which has an ultrasonic sensor device, for determining an object property of an environment object, wherein for each of a plurality of detection situations of the environment object, a respective classification model for determining a classification result which specifies a modeled object property of the environment object is provided, wherein each respective classification model is trained for evaluation with a different subset of a quantity of signal characteristics extracted from ultrasonic reception signals of the ultrasonic sensor device to provide a classification result of the corresponding respective classification model and an associated quality specification in each case, said method comprising:
detecting the ultrasonic reception signals of ultrasonic transducers of the ultrasonic sensor device;
determining the quantity of signal characteristics from the ultrasonic reception signals;
determining one or more classification results and associated quality specifications by evaluating one or more of the respective classification models with the corresponding subset of the quantity of the signal characteristics based on the detection situation; and
determining the object property based on the one or more classification results and associated quality specifications.

2. The method according to claim 1, further comprising:
determining a detection situation of the environment object;
selecting a current classification model from the plurality of respective classification models on the basis of the determined detection situation;
determining a classification result using the selected current classification model; and
determining the object property based on the classification results and associated quality specifications.

3. The method according to claim 2, further comprising:
upon determining that an environment object leaves a detection situation, temporarily storing the classification result last determined with the respective classification model assigned to the detection situation and the associated quality specification,
wherein the determination of the object property is determined based on the classification result obtained with the current classification model and the associated quality specification and on the temporarily stored classification result and the associated quality specification.

4. The method according to claim 3, wherein the object property is determined by the temporarily stored classification result as long as the associated quality specification of the temporarily stored classification result indicates a higher quality than the associated quality specification of the classification result determined with the current classification model.

5. The method according to claim 3, further comprising:
when determining that an environment object leaves a detection situation, resetting the signal characteristics which are based on historical profiles of the ultrasonic reception signals.

6. The method according to one of claim 2, wherein the detection situation depends on a position of the environment object and/or a speed of the environmental object.

7. The method according to claim 1, wherein:
the determining of the one or more classification results includes evaluating each of the respective classification models with the relevant subset of the quantity of signal characteristics to obtain the corresponding classification result and the associated quality specification; and
the determining of the object property includes determining the object property by the classification result of which the associated quality specification indicates the highest quality.

8. An apparatus for carrying out the method according claim 1.

9. A computer program product comprising commands which, when the program is run by a computer, cause said computer to execute the method according to claim 1.

10. A non-transitory machine-readable storage medium, comprising commands which, when executed by a computer, cause said computer to execute the method according to claim 1.

11. The method according to claim 2, wherein the determining of the detection situation of the environment object includes determining the detection situation of the environmental object by localization with the aid of the ultrasonic sensor device.
